(19) United States
(12) Patent Application Publication
(10) Pub. No.: US 2015/0074365 A1
(43) Pub. Date: Mar. 12, 2015

(54) INFORMATION PROCESSING APPARATUS AND DUPLICATION METHOD

(71) Applicant: FUJITSU LIMITED, Kawasaki (JP)

(72) Inventor: Mikio UEHARA, Kawasaki (JP)

(73) Assignee: Fujitsu Limited, Kawasaki (JP)

(21) Appl. No.: 14/546,513

(22) Filed: Nov. 18, 2014

Related U.S. Application Data
(63) Continuation of application No. PCT/JP2012/063538, filed on May 25, 2012.

(51) Int. Cl. G06F 1/30; G06F 11/14

(52) U.S. Cl. CPC G06F 1/30; G06F 11/1451
USPC 711/162

(57) ABSTRACT

An information processing apparatus duplicates the state of the own apparatus into a storage device at the time of the loss of a power supply. Furthermore, the information processing apparatus duplicates a difference of the state of the own apparatus at a predetermined time interval. Furthermore, the information processing apparatus estimates the time period needed to duplicate the difference. Then, the information processing apparatus determines whether the estimated time period is longer than the time period for which a battery operates the information processing apparatus at the time of the loss of the power supply. When the information processing apparatus determines that the estimated time period is longer than the time period for which the battery operates the information processing apparatus, the information processing apparatus reduces the time interval of the duplication.

### CROSS-REFERENCE TO RELATED APPLICATION

This application is a continuation of International Application No. PCT/JP2012/063538, filed on May 25, 2012, the entire contents of which are incorporated herein by reference.

### FIELD

The embodiments discussed herein are related to an information processing apparatus and a duplication method.

### BACKGROUND

As power supply systems used in information processing apparatuses, such as servers, there is a conventional known technology of an uninterruptible power supply (UPS) or the like, that supplies electrical power from a battery when a supply of electrical power is stopped due to a power failure. Furthermore, there is a known technology in which, instead of the UPS, a battery is connected to a power supply and electrical power is supplied from the battery when a power failure occurs.

With the technology in which electrical power is supplied from a battery in this way, if a supply of electrical power is stopped due to a power failure or the like, the battery supplies electrical power to an information processing apparatus during a period of time until an operating system (OS) in the information processing apparatus is normally shut down. See, for example, Japanese Laid-open Patent Publication No. 2002-101572 and Japanese National Publication of International Patent Application No. 2008-522322.

However, with the technology in which a battery supplies electrical power to an information processing apparatus, there is a problem in that, because the battery supplies electrical power to the information processing apparatus during a period of time until an OS is normally shut down after a power failure has occurred, the capacity of the battery needs to be large.

For example, if the OS is not able to shut down normally during a period of time until the battery supplies electrical power to the information processing apparatus, a dirty shutdown occurs. However, because the period of time needed to shut down the OS is not specified, the capacity of the battery needs to be large such that the OS can perform a normal shutdown.

### SUMMARY

According to an aspect of an embodiment, an information processing apparatus that duplicates the state of the own apparatus into a storage device at the time of the loss of a power supply is provided. Furthermore, the information processing apparatus duplicates, at a predetermined time interval, a difference of the state of the information processing apparatus. Furthermore, the information processing apparatus estimates the time period needed to duplicate the difference. Then, the information processing apparatus determines whether the estimated time period is longer than the time period for which a battery that supplies electrical power to the information processing apparatus at the time of the loss of the power supply operates the information processing apparatus. If the information processing apparatus determines that the estimated time period is longer than the time period for which the battery operates the information processing apparatus, the information processing apparatus updates the time interval for which the duplication is executed to a smaller value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an information processing system according to a first embodiment;

FIG. 2 is a schematic diagram illustrating duration association information according to the first embodiment;

FIG. 3 is a schematic diagram illustrating an example of a power supply unit and a battery module according to the first embodiment;

FIG. 4 is a schematic diagram illustrating an example of a state display LED unit according to the first embodiment;

FIG. 5 is a schematic diagram illustrating software executed by a server according to the first embodiment;

FIG. 6 is a schematic diagram illustrating the estimated backup time period;

FIG. 7 is a flowchart illustrating the flow of a process executed by management software according to the first embodiment;

FIG. 8 is a flowchart illustrating the flow of a process executed by a time calculation subroutine; and

FIG. 9 is a sequence diagram illustrating the operation of the information processing system according to the first embodiment.

### DESCRIPTION OF EMBODIMENT(S)

Preferred embodiments of the present invention will be explained with reference to accompanying drawings.

### [a] First Embodiment

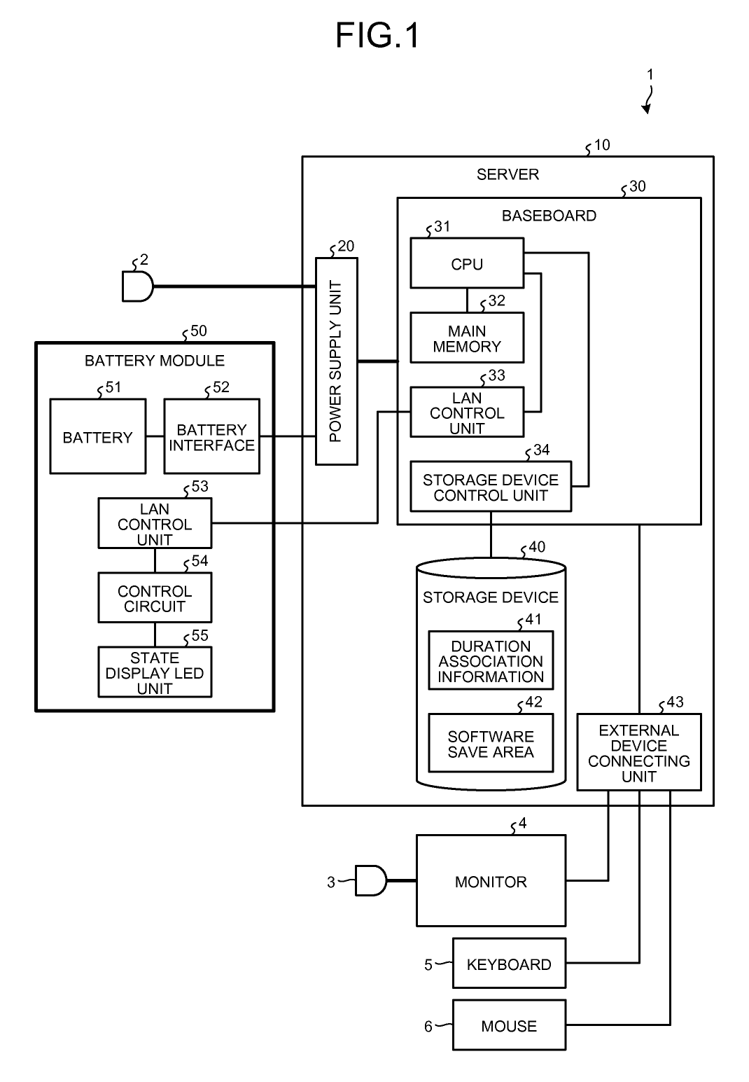

In a first embodiment, an example of an information processing system that includes a server that performs a differential backup will be described with reference to FIG. 1. FIG. 1 is a schematic diagram illustrating an information processing system according to a first embodiment.

As illustrated in FIG. 1, an information processing system 1 includes a power supply 2, a power supply 3, a monitor 4, a keyboard 5, a mouse 6, a server 10, and a battery module 50. Furthermore, the server 10 includes a power supply unit 20, a baseboard 30, a storage device 40, and an external device connecting unit 43.

Furthermore, the baseboard 30 includes a central processing unit (CPU) 31, a main memory 32, a local area network (LAN) control unit 33, and a storage device control unit 34. Furthermore, the storage device 40 stores therein duration association information 41 and includes a software save area 42. The battery module 50 includes a battery 51, a battery interface 52, a LAN control unit 53, a control circuit 54, and a state display light emitting diode (LED) unit 55. In the example illustrated in FIG. 1, the server 10 includes the baseboard 30; however, the embodiment is not limited thereto. The server 10 may also include a plurality of baseboards that have the same function as that performed by the baseboard 30.

The power supply 2 is a power supply that supplies electrical power to the server 10. Furthermore, the power supply 3 is a power supply that supplies electrical power to the monitor 4. At this point, if a failure, such as a power failure, occurs, the power supply 2 and the power supply 3 stop supplying the electrical power to the server 10 and the monitor 4.

The monitor 4 is a display device that is connected to the server 10 and that displays a graphical user interface (GUI) that is used to display the state of the server 10 or that is used to operate the server 10. The keyboard 5 is a keyboard that is used to input, for example, character information to the server 10. The mouse 6 is a mouse for a cursor operation in the GUI provided by the server 10 via the monitor 4.

The monitor 4 receives a supply of electrical power from the power supply 3 that is a different system as that of the server 10. Consequently, it is assumed that, if a failure, such as a power failure, occurs, the monitor 4 is not able to receive a supply of electrical power and thus it is not possible to display, for example, the state of the server 10.

The server 10 and the battery module 50 are connected via a LAN and can communicate with each other. For example, the server 10 sends a query about the charging rate of the battery 51 to the battery module 50. Then, the battery module 50 notifies the server 10 of the charging rate of the battery 51.

Furthermore, the server 10 and the battery module 50 are connected by an electrical power line through which electrical power is supplied. Then, the server 10 supplies electrical power to the battery module 50. Namely, the server 10 supplies, to the battery module 50, a part of the electrical power that is supplied by the power supply 2 to the server 10. Furthermore, if a supply of electrical power from the power supply 2 to the server 10 stops, i.e., if a power failure or the like has occurred, the battery module 50 supplies electrical power accumulated in the battery 51 to the server 10.

In the following, the storage device 40 included in the server 10 will be described. The storage device 40 is a storage device that is included in the server 10 and that is targeted for a backup of the state of the server 10 when the server 10 executes a backup. Furthermore, the storage device 40 stores therein the duration association information 41 and maintains a part of the storage area as the software save area 42.

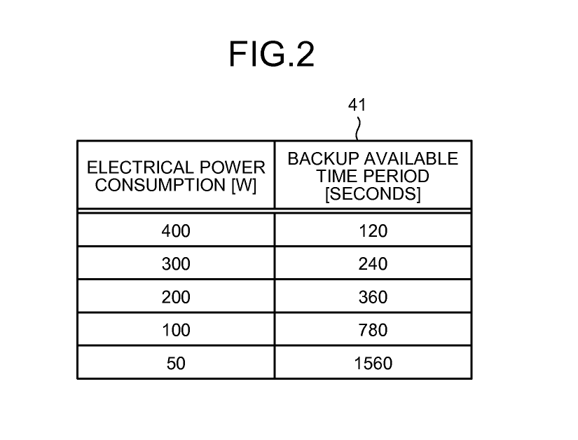

In the following, the duration association information 41 stored in the storage device 40 included in the server 10 will be described with reference to FIG. 2. FIG. 2 is a schematic diagram illustrating duration association information according to the first embodiment. As illustrated in FIG. 2, the duration association information 41 includes a plurality of entries in each of which the electrical power consumption (Watt (W)) of the server 10 is associated with a backup available time period (seconds).

The electrical power consumption of the server 10 mentioned here is the electrical power consumed when the server 10 performs a backup. Furthermore, the backup available time period is a period of time for which the server 10 can back up by using the electrical power supplied from the battery module 50. Namely, in the example illustrated in FIG. 2, the duration association information 41 indicates that, when the electrical power consumption of the server 10 is 400 W, the backup available time period is 120 seconds. Furthermore, the duration association information 41 indicates that, when the electrical power consumption of the server 10 is 300 W, the backup available time period is 240 seconds.

Furthermore, the duration association information 41 indicates that, when the electrical power consumption of the server 10 is 200 W, the backup available time period is 360 seconds. Furthermore, the duration association information 41 indicates that, when the electrical power consumption of the server 10 is 100 W, the backup available time period is 780 seconds. Furthermore, the duration association information 41 indicates that, when the electrical power consumption of the server 10 is 50 W, the backup available time period is 1,560 seconds.

In the following, the software save area 42 included in the storage device 40 will be described. The software save area 42 is an area that is used to store therein data when the OS executed by the server 10 backs up the state of the server 10. Data stored in the software save area 42 by the server 10 will be described below.

For example, the server 10 operates a virtual program referred to as a hypervisor and runs a virtual machine (VM) on the hypervisor. Then, the server 10 installs a guest OS in the VM and operates an application in the guest OS. Then, by using the backup function included in the hypervisor, the server 10 backs up data on VMs, guest OSs, and applications running on the hypervisor to the software save area 42.

Specifically, the server 10 stores, in the software save area 42, the data on the VMs, the guest OSs, and the applications that are used to reproduce the state of the server 10 at the time of the backup. Furthermore, the server 10 regularly performs a backup, for example, every hour. At this point, in order to reduce the period of time needed for a backup, for a second backup and the subsequent backup, the server 10 performs a differential backup in which only a difference between the immediately previous backup is backed up.

In the following, a description will be given of, by referring back to FIG. 1, the power supply unit 20, the baseboard 30, and the external device connecting unit 43 included in the server 10. When the power supply unit 20 acquires the electrical power supplied from the power supply 2, the power supply unit 20 converts the acquired electrical power to a DC voltage in accordance with the baseboard 30 or each of the devices included in the server 10 and then supplies the converted electrical power to the various devices. Furthermore, the power supply unit 20 supplies a part of the acquired electrical power to the various devices included in the server 10, such as the baseboard 30 or the like. Furthermore, the power supply unit 20 supplies a part of the electrical power supplied from the power supply 2 to the battery module 50.

The CPU 31 is an arithmetic processing unit that performs various arithmetic processing. Specifically, the CPU 31 executes the software, such as the hypervisor, the VM, the guest OS, and the application operated by the server 10 and then operates them. The main memory 32 is a storage device that is used when the CPU 31 executes the each piece of the software.

The LAN control unit 33 is a control device that controls communication with the battery module 50. For example, the LAN control unit 33 has a function of controlling the communication between the server 10 and another server that is not illustrated in FIG. 1. Furthermore, the storage device control unit 34 reads information stored in the storage device 40 or writes information into the storage device 40. Furthermore, the external device connecting unit 43 performs control of information that is displayed on the monitor 4 or performs control of an input from the keyboard 5 or the mouse 6.

The CPU 31, the main memory 32, the LAN control unit 33, and the storage device control unit 34 described above execute the following process by using the hypervisor or the management software, which will be described later. First, the CPU 31 executes, at a predetermined time interval, a differential backup of data on the hypervisor, the VM, the guest OS, the application, or the like present in the main memory 32.

Specifically, the CPU 31 identifies data corresponding to a difference between the immediately previous backup and then sends the identified data to the storage device control unit 34. Then, the storage device control unit 34 stores the data received from the CPU 31 in the software save area 42 in the storage device 40. Furthermore, the CPU 31 measures the time period needed for the differential backup and estimates, on the basis of the measured time period, the time period needed to shut down at the time of the loss of a power supply. Specifically, the CPU 31 estimates the time period for which the hypervisor stops the operation of the guest OS; backs up the difference of the VM, the guest OS, and the application; shuts down the hypervisor; and turns off the power supply of the server 10.

Furthermore, the CPU 31 sends a query about the charging rate of the battery 51 to the battery module 50 via the LAN control unit 33. Furthermore, the CPU 31 identifies the electrical power consumption of the server 10 and identifies the backup available time period that is associated with the identified electrical power consumption from the duration association information 41. Then, the CPU 31 uses the product of the charging rate of the battery 51 and the backup available time period as the time period for which the battery module 50 can operate the server 10.

Thereafter, the CPU 31 determines whether the time period needed to shut down at the time of the loss of a power supply is longer than the time period for which the battery module 50 operates the server 10. If the CPU 31 determines that the time period needed to shut down at the time of the loss of a power supply is longer than the time period for which the battery module 50 operates the server 10, the CPU 31 reduces the time interval of the differential backup. Namely, by increasing the number of times the CPU 31 executes the differential backup, the CPU 31 reduces an amount of data targeted for a backup and shorten the period of time it takes to shut down at the time of the loss of a power supply.

Furthermore, after the time interval of the differential backup is reduced, if the time interval of the differential backup becomes shorter than the predetermined time interval, the CPU 31 notifies a user of a warning. Namely, the CPU 31 notifies a user that a normal shutdown is not possible with the current capacity of the battery 51.

Furthermore, when the CPU 31 acquires a notification from the battery module 50 via the LAN control unit 33 indicating that the power supply 2 has been lost, the CPU 31 executes a shutdown. Furthermore, when the CPU 31 starts the shutdown, the CPU 31 notifies the battery module 50 via the LAN control unit 33 indicating that the CPU 31 is going to execute the shutdown.

Furthermore, when the CPU 31 turns off the power supply of the server 10, the CPU 31 notifies the battery module 50 via the LAN control unit 33 indicating that the CPU 31 turns off the power supply of the server 10. Furthermore, if the time interval of the differential backup becomes shorter than the predetermined set interval, the CPU 31 notifies the battery module 50 via the LAN control unit 33 indicating that the CPU 31 is not able to perform a shutdown normally.

In the following description, a period of time for which the battery module 50 can operate the server 10 is referred to as the battery time period. Furthermore, in the following description, an estimated period of time needed to shut down from a loss of the power supply 2 is referred to as the estimated backup time period.

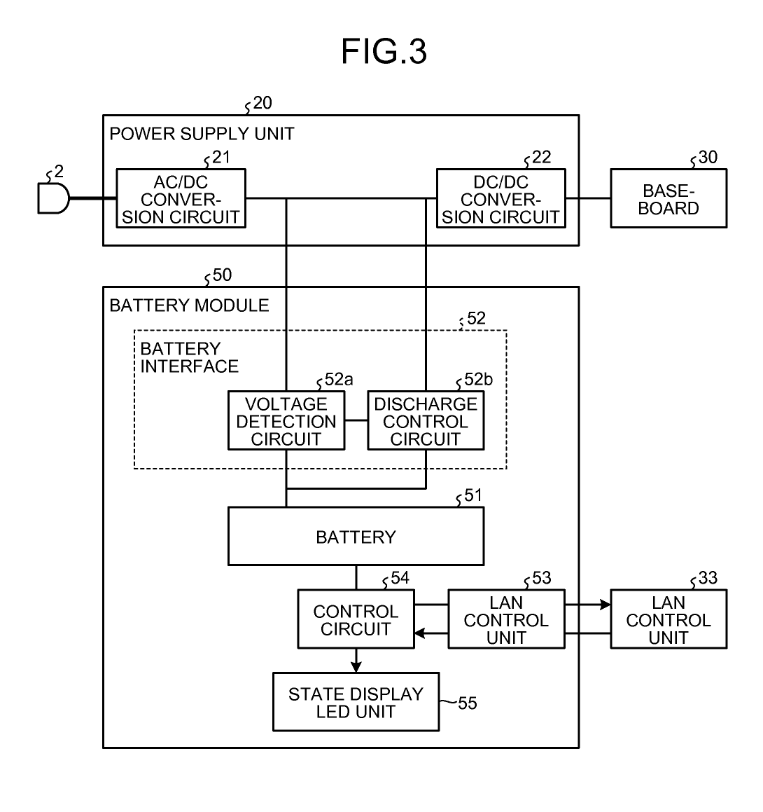

In the following, the power supply unit 20 and the battery module 50 will be described with reference to FIG. 3. FIG. 3 is a schematic diagram illustrating an example of a power supply unit and a battery module according to the first embodiment. In the example illustrated in FIG. 3, the power supply unit 20 includes an alternating Current (AC)/direct current (DC) conversion circuit 21 and a DC/DC conversion circuit 22. Furthermore, the battery interface 52 includes a voltage detection circuit 52a and a discharge control circuit 52b.

The AC/DC conversion circuit 21 converts an alternating current, which is supplied from the power supply 2, to a direct current and then outputs the converted direct current to the DC/DC conversion circuit 22. Furthermore, the AC/DC conversion circuit 21 supplies a part of the converted direct current to the battery module 50. The DC/DC conversion circuit 22 converts the voltage of the direct current that is input from the AC/DC conversion circuit 21 to the voltage in accordance with the baseboard 30 and then inputs the converted direct current to the baseboard 30.

Although not illustrated in FIG. 3, in addition to the baseboard 30, the DC/DC conversion circuit 22 converts the direct current input from the AC/DC conversion circuit 21 to a direct current with a voltage in accordance with the standard of each of the devices included in the server 10 and then inputs the converted direct current to each of the devices.

The battery 51 is a battery that stores therein electrical power. Furthermore, if a direct current is input from the AC/DC conversion circuit 21, the voltage detection circuit 52a charges the battery 51 by using the input direct current. Furthermore, if the battery 51 is in a fully charged state, the voltage detection circuit 52a does not charge the battery 51. Furthermore, in accordance with the voltage of the direct current input from the AC/DC conversion circuit 21, the voltage detection circuit 52a detects a loss of the power supply 2, such as a power failure or the like.

For example, when the voltage of the direct current falls below a predetermined threshold, if the voltage becomes “0”, the voltage detection circuit 52a determines that the state is a loss of the power supply 2. If the voltage detection circuit 52a determines that the state is a loss of the power supply 2, the voltage detection circuit 52a instructs the discharge control circuit 52b to supply electrical power to the server 10.

The discharge control circuit 52b supplies the electrical power that has been charged in the battery 51 to the server 10. Specifically, when the discharge control circuit 52b is instructed by the voltage detection circuit 52a to supply electrical power to the server 10, the discharge control circuit 52b supplies electrical power to the server 10 by inputting the electrical power charged in the battery 51 to the DC/DC conversion circuit 22.

The LAN control unit 53 is a control unit that controls the communication with the LAN control unit 33 included in the server 10. The control circuit 54 is a control circuit that performs various kinds of control of the battery module 50. Specifically, if the control circuit 54 receives an inquiry about the charging rate of the battery 51 from the LAN control unit 53, the control circuit 54 measures the charging rate of the battery 51 and sends the measured charging rate to the baseboard 30 via the LAN control unit 53. In a description below, the charging rate of the battery 51 is represented by a percent.

Furthermore, on the basis of a charge state of the battery 51 or on the basis of a notification from the server 10, the control circuit 54 controls the state display LED unit 55 and notifies a user of the charge state of the battery 51 or the state of the server 10. Furthermore, by using the voltage of the electrical power supplied from the power supply unit 20, the control circuit 54 determines whether the state is a loss of the power supply 2. If the control circuit 54 determines that the state is a loss of the power supply 2, the control circuit 54 notifies the server 10 via the LAN control unit 53 that a power failure has occurred. For a method of measuring the charging rate of the battery 51, a conventional method, such as a method of measuring a voltage of a terminal of the battery 51 that performs the charging and discharging, is used.

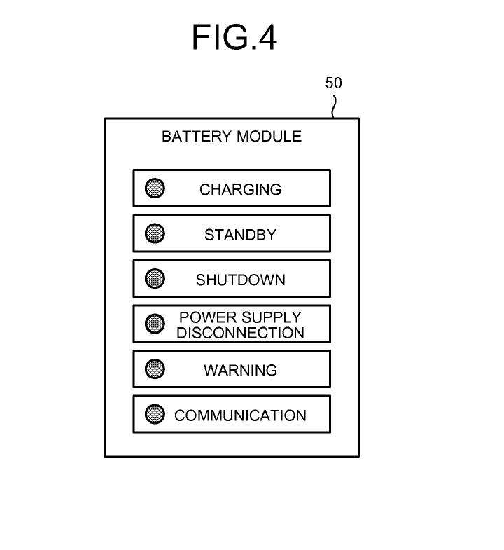

The state display LED unit 55 is a display device that displays the state of the server 10 and the battery module 50. In the following, an example of the state display LED unit 55 will be described with reference to FIG. 4. FIG. 4 is a schematic diagram illustrating an example of a state display LED unit according to the first embodiment. In the example illustrated in FIG. 4, the state display LED unit 55 includes, as illustrated by the shaded area in FIG. 4, a charging LED, a standby LED, a shutdown LED, a power supply disconnection LED, a warning LED, and a communication LED.

The charging LED mentioned here is an LED that indicates whether the battery module 50 currently charges the battery 51. The standby LED mentioned here is an LED that indicates whether, when a power failure occurs, the system is waiting for a shutdown. The shutdown LED mentioned here is an LED that indicates whether the server 10 has saved the data on the hypervisor, the VMs, the guest OSs, and the applications and is executing a shutdown.

The power supply disconnection LED mentioned here is an LED that indicates whether the power supply of the server 10 has been disconnected. The warning LED mentioned here is an LED that indicates whether an estimated backup time period is longer than the battery time period. The communication LED mentioned here is an LED that indicates whether the battery module 50 and the server 10 communicate with each other.

The control circuit 54 controls each LED included in the state display LED unit 55, thereby the control circuit 54 notifies a user of the state of the server 10 and the battery module 50. For example, if the battery 51 is being charged, the control circuit 54 turns on the LED that indicates the battery 51 is being charged. Furthermore, the control circuit 54 turns on the standby LED during a period of time from when the voltage detection circuit 52a detects a loss of the power supply 2 until a notification indicating that a shutdown is going to be executed is received.

Furthermore, when the control circuit 54 receives a notification indicating that a shutdown is going to be executed, the control circuit 54 turns on the shutdown LED. Furthermore, when the control circuit 54 receives a notification indicating that the power supply 2 is turned off, the control circuit 54 turns on the power supply disconnection LED. Furthermore, when the control circuit 54 receives a notification indicating that a normal shutdown is not able to be performed, the control circuit 54 turns on the warning LED. Furthermore, when the LAN control unit 53 performs communication, the control circuit 54 notifies, by turning on the communication LED, a user whether communication is being performed.

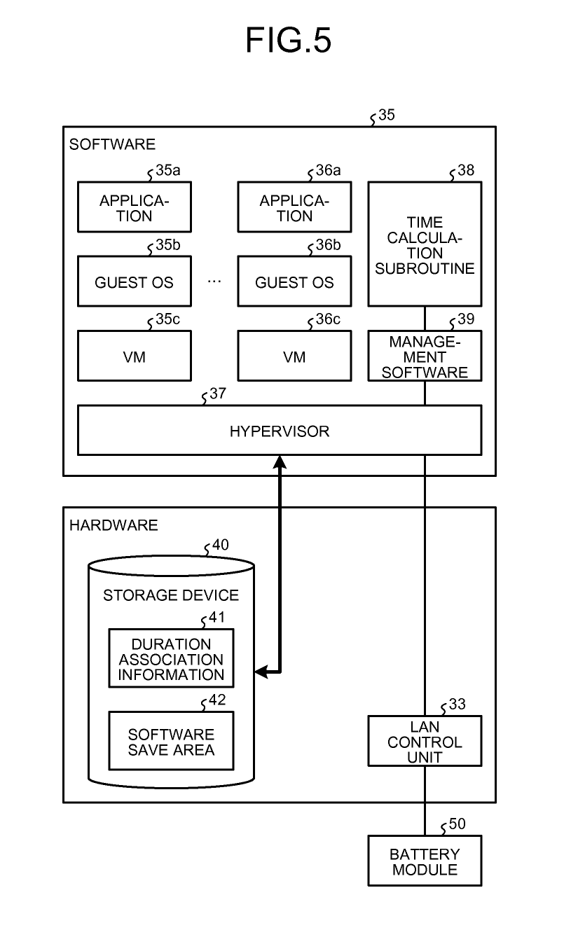

In the following, software, such as the hypervisor, the VM, the guest OS, the application, or the like executed by the server 10 will be described with reference to FIG. 5. FIG. 5 is a schematic diagram illustrating software executed by a server according to the first embodiment. FIG. 5 illustrates software 35 executed by the server 10. As illustrated in FIG. 5, the software 35 includes therein a hypervisor 37, a time calculation subroutine 38, and management software 39.

Furthermore, on the hypervisor 37, a plurality of VM 35c and VM 36c are running and, on the VM 35c and the VM 36c, a guest OS 35b and a guest OS 36b are running. Furthermore, on the guest OS 35b, an application 35a is running and, on the guest OS 36b, an application 36a is running. Furthermore, similarly to the application 36a, the time calculation subroutine 38 and the management software 39 may also be a program running on the guest OS 36b.

At this point, when the hypervisor 37 receives an instruction to execute a differential backup from the management software 39, the hypervisor 37 executes the differential backup. Specifically, the hypervisor 37 executes the differential backup of data on the application 35a, the application 36a, the guest OS 35b, the guest OS 36b, the VM 35c, and the VM 36c into the software save area 42.

The management software 39 issues, to the hypervisor 37, an instruction to execute a differential backup at a predetermined time interval. Furthermore, the management software 39 measures the period of time needed by the hypervisor 37 from the starting to the end of the differential backup and measures the task operation rate of the server 10 during a period of time for which the hypervisor 37 is executing the differential backup. Furthermore, the management software 39 measures the electrical power consumption of the server 10 when the differential backup is being executed.

The task operation rate of the server 10 mentioned here is the operation rate of, for example, the CPU 31 during a period of time for which a differential backup is being executed. Then, the management software 39 uses the product of the measured time and the operation rate as the estimated period of time needed for a backup at the time of the loss of a power supply, i.e., the estimated backup time period.

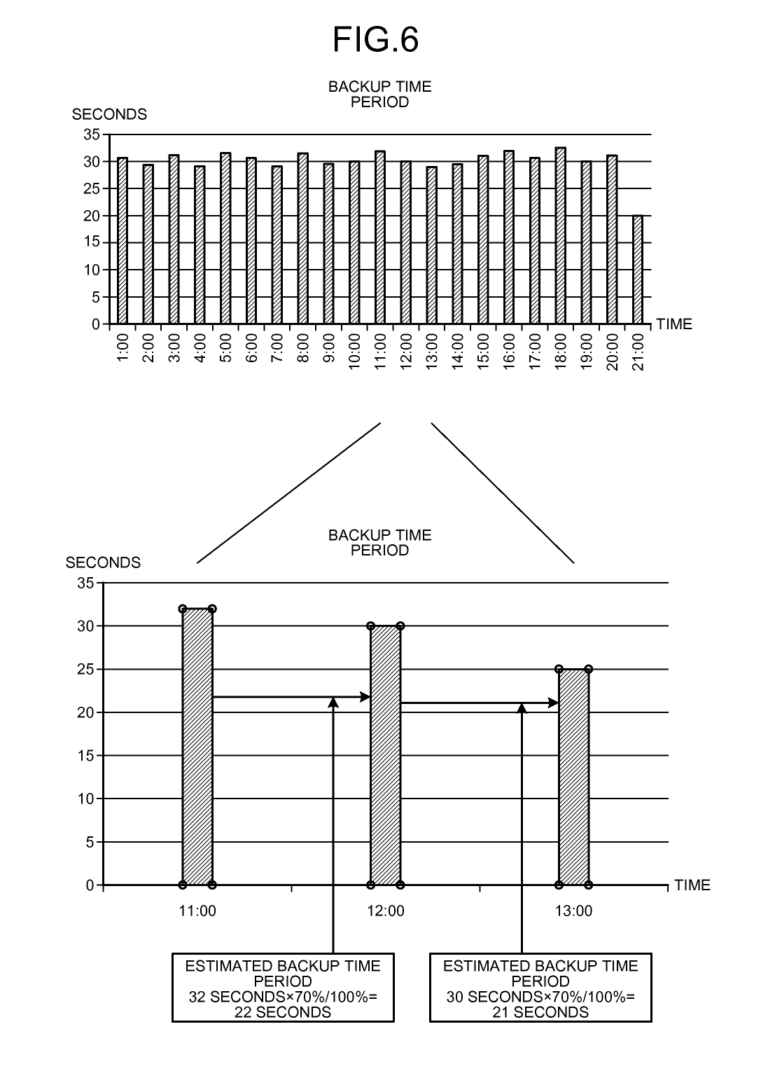

Here, FIG. 6 is a schematic diagram illustrating the estimated backup time period. FIG. 6 illustrates a graph in which the horizontal axis represents the time at which the server 10 executes the differential backup and the vertical axis represents the period of time needed for each differential backup. The lower portion of the graph illustrated in FIG. 6 is obtained by enlarging the period of time needed for the server 10 when the server 10 executes the differential backup at 11:00, 12:00, and 13:00.

For example, in the example illustrated in the upper portion of FIG. 6, the server 10 executes a differential backup every one hour. At this point, as illustrated in the lower portion of FIG. 6, the server 10 needs 32 seconds for the differential backup executed at 11:00. At this point, the server 10 stops another process at the time of the loss of a power supply and executes a differential backup at the task operation rate of 100 percent.

Here, if it is assumed that the task operation rate when the differential backup is executed is 70 percent, the management software 39 calculates the estimated backup time period as 22 (seconds) obtained from the calculation of 32 (seconds)×70/100. Namely, if a loss of a power supply occurs by 12:00, the management software 39 estimates that it needs 22 seconds for the differential backup.

Furthermore, it is assumed that the operation rate of the server 10 when the differential backup is executed at 12:00 is 70 percent and it is assumed that it takes 30 seconds for the differential backup. Then, the management software 39 calculates the estimated backup time period as 21 seconds obtained from the calculation of 30 (seconds)×70/100. Namely, if a loss of a power supply occurs by 13:00, the management software 39 estimates that it takes 21 seconds for the differential backup.

Then, the management software 39 calls the time calculation subroutine 38 and calculates a period of time for which the battery module 50 operates the server 10, i.e., the battery time period. Thereafter, the management software 39 determines whether the estimated backup time period is longer than the battery time period. If the estimated backup time period is longer than the battery time period, the management software 39 shortens the time interval for which an instruction to execute a differential backup is issued. Namely, the management software 39 shortens the time interval for which a differential backup is executed.

Furthermore, the management software 39 determines whether the time interval for which a differential backup is executed is shorter than a predetermined threshold. If the time interval for which a differential backup is executed is shorter than a predetermined threshold, the management software 39 warns a user via the monitor 4 indicating that a backup is not able to be performed normally. Furthermore, the management software 39 issues a notification indicating a shutdown is not able to be performed normally to the control circuit 54 in the battery module 50.

A description will be given here by referring back to FIG. 5. By using both the electrical power consumed by the server 10 that is executing the differential backup and the charging rate of the battery 51, the time calculation subroutine 38 calculates a backup time period. Specifically, if the time calculation subroutine 38 is called by the management software 39, the time calculation subroutine 38 reads, from the duration association information 41, the backup available time period that is associated with the electrical power consumption measured by the management software 39. Furthermore, the time calculation subroutine 38 sends a query about the charging rate of the battery 51 to the battery module 50 via the LAN control unit 33.

Then, by using both the charging rate of the battery 51 and the read backup available time period, the time calculation subroutine 38 calculates a battery time period. Specifically, the time calculation subroutine 38 uses the product of the charging rate of the battery 51 and the backup available time period as the battery time period. Then, the time calculation subroutine 38 returns the battery time period to the management software 39 and then ends the process. The reading of the backup available time period performed by the time calculation subroutine 38 and the inquiry about the charging rate of the battery 51 are performed via the management software 39 and the hypervisor 37.

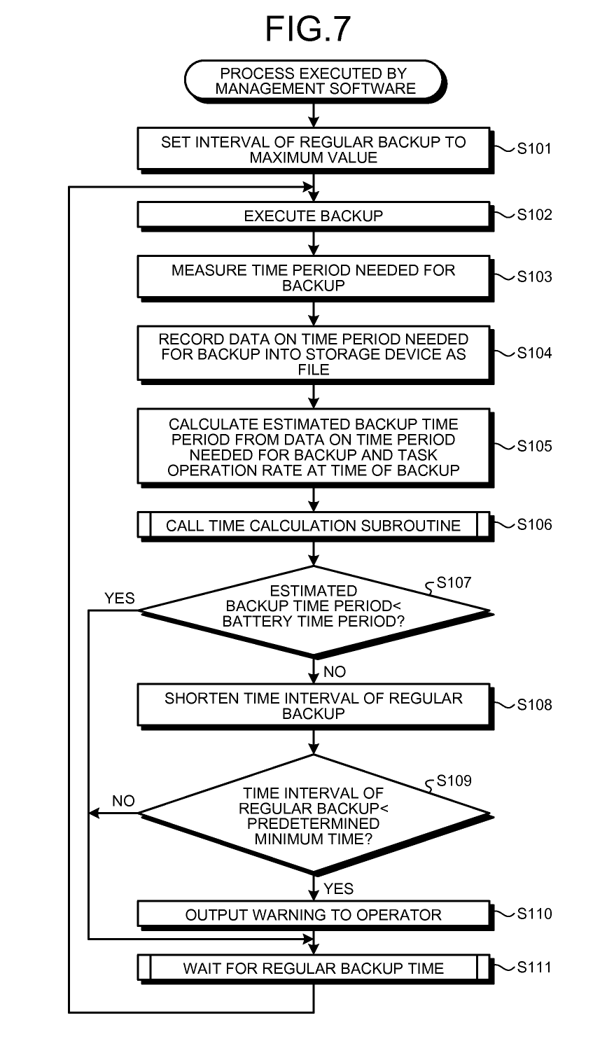

In the following, the flow of a process performed by the management software 39 will be described with reference to FIG. 7. FIG. 7 is a flowchart illustrating the flow of a process executed by management software according to the first embodiment. In the example illustrated in FIG. 7, when the server 10 is started up, the management software 39 sets the interval of a regular backup to the maximum value (Step S101).

Then, the management software 39 allows the hypervisor 37 to execute the backup (Step S102). Furthermore, the management software 39 measures a period of time needed to execute the backup (Step S103). Then, the management software 39 records the data on the period of time needed to execute the backup into the storage device 40 as a file (Step S104). Then, the management software 39 calculates an estimated backup time period from the data on the period of time needed to execute the backup and the task operation rate at the time of backup (Step S105).

Subsequently, the management software 39 calls the time calculation subroutine 38 to calculate the battery time period (Step S106). Then, the management software 39 determines whether the estimated backup time period is shorter than the battery time period (Step S107). At this point, if estimated backup time period is shorter than the battery time period (No at Step S107), the management software 39 shortens the time interval of the regular backup (Step S108).

Then, the management software 39 determines whether the time interval of the regular backup is shorter than a predetermined minimum time (Step S109). If the time interval of the regular backup is shorter than the predetermined minimum time period (Yes at Step S109), the management software 39 outputs a warning to an operator (Step S110) and waits for the regular backup time (Step S111).

Then, the management software 39 re-executes the process at Step S102. In contrast, if the estimated backup time period is shorter than the battery time period (Yes at Step S107), the management software 39 executes the process at Step S111. Furthermore, if the time interval of the regular backup is greater than the predetermined minimum time (No at Step S109), the management software 39 executes the process at Step S111.

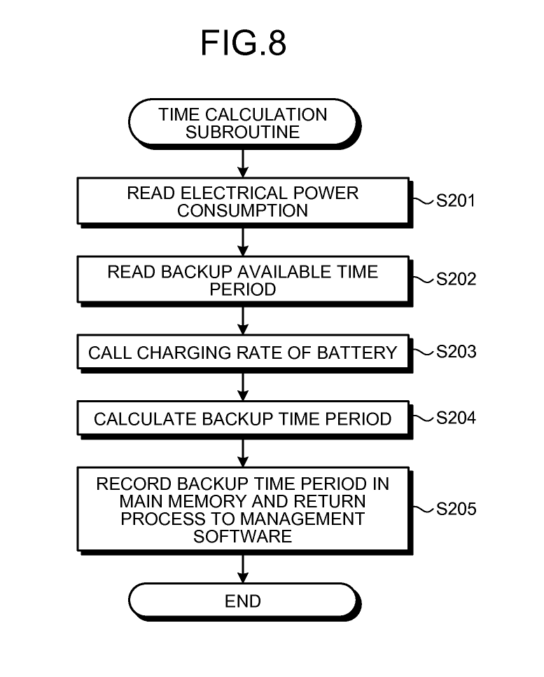

In the following, the flow of the process executed by the time calculation subroutine 38 will be described with reference to FIG. 8. FIG. 8 is a flowchart illustrating the flow of a process executed by a time calculation subroutine. The process illustrated in FIG. 8 corresponds to the process at Step S106 illustrated in FIG. 7. First, the time calculation subroutine 38 reads the electrical power consumption of the server 10 (Step S201).

Then, the time calculation subroutine 38 reads the backup available time period from the duration association information 41 (Step S202). Then, the time calculation subroutine 38 calls the charging rate of the battery (Step S203) and calculates the backup time period (Step S204). Then, the time calculation subroutine 38 records the backup time period in the main memory 32, returns the process to the management software 39 (Step S205), and then ends the process.

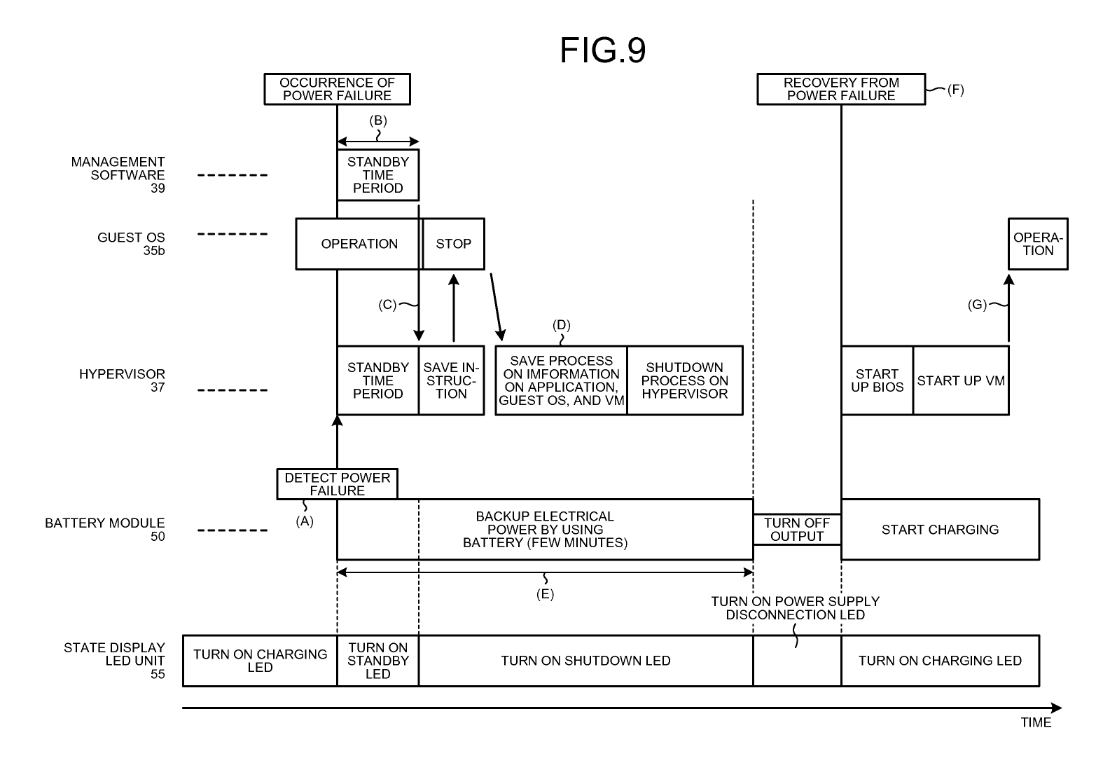

In the following, the operation of the information processing system 1 performed when a power failure occurs will be described with reference to FIG. 9. FIG. 9 is a sequence diagram illustrating the operation of the information processing system according to the first embodiment. FIG. 9 illustrates an example of the operation of the management software 39, the guest OS 35b, the hypervisor 37, the battery module 50, and the state display LED unit 55 performed when a power failure occurs.

For example, as indicated by (A) illustrated in FIG. 9, if a power failure occurs, the battery module 50 detects the power failure and notifies the hypervisor 37 of the power failure. Then, as indicated by (B) illustrated in FIG. 9, the hypervisor 37 and the management software 39 monitors the state in order to determine whether the power failure continues for a predetermined period of time. If the power failure continues for a predetermined period of time, as indicated by (C) illustrated in FIG. 9, the management software 39 notifies the hypervisor 37 via the guest OS 35b of the starting of a shutdown.

Then, the hypervisor 37 issues a save instruction to the guest OS 35b and then stops the guest OS 35b. Thereafter, as indicated by (D) illustrated in FIG. 9, the hypervisor 37 saves the data on the applications 35a and 36a, the guest OSs 35b and 36b, and the VMs 35c and 36c. Namely, the hypervisor 37 executes the differential backup of the software 35 and stores the data into the software save area 42.

Thereafter, the hypervisor 37 shuts down the hypervisor 37. At this point, as indicated by (E) illustrated in FIG. 9, the battery module 50 supplies electrical power from the battery 51 for a period of time from when a power failure has occurred until when the hypervisor 37 is shut down and the power supply of the server 10 is turned off. Then, the battery module 50 shifts the own state into a sleep state and then turns off the output.

Then, as indicated by (F) illustrated in FIG. 9, when the power failure is recovered, the hypervisor 37 starts up a basic input/output system (BIOS) and then starts up the VM 35c. Consequently, at (G) illustrated in FIG. 9, the started VM 35c operates the guest OS 35b. Furthermore, at (F) illustrated in FIG. 9, when the power failure is recovered, the battery module 50 starts the charging of the battery 51.

Furthermore, the state display LED unit 55 turns on the charging LED until the power failure is detected at (A) illustrated in FIG. 9 and turns on the standby LED during the period of time indicated by (B) illustrated in FIG. 9. Then, the state display LED unit 55 turns on the shutdown LED at (C) illustrated in FIG. 9 during the period of time from when the hypervisor 37 starts to save the software 35 until the hypervisor 37 is shut down. Thereafter, the state display LED unit 55 turns on the power supply disconnection LED. Furthermore, as indicated by (F) illustrated in FIG. 9, when the power failure is recovered, the state display LED unit 55 turns on the charging LED.

### Advantage of the First Embodiment

As described above, at the time of the loss of a power supply, the server 10 has a function of executing a backup of the state of the server 10, i.e., a backup of the data in the software 35 executed by the server 10, into the storage device 40. Furthermore, the server 10 executes a differential backup at a predetermined time interval. Furthermore, the server 10 estimates the time period needed for the differential backup and determines whether the estimated backup time period is longer than the battery time period. Then, if the estimated backup time period is longer than the battery time period, the server 10 shortens the time interval for which the differential backup is executed.

Accordingly, the server 10 can reduce the capacity of the battery 51. Namely, by regularly executing a differential backup, the server 10 can shorten the time period needed to execute a backup at the time of the loss of a power supply. Furthermore, the server 10 estimates the time period needed for a backup performed at the time of the loss of a power supply. If the estimated time is longer than the time period for which the battery 51 operates the server 10, the server 10 shortens the time interval for which the differential backup is executed.

Consequently, the server 10 reduces an amount of data that is targeted for the differential backup at the time of the loss of a power supply and shortens the time period needed for the differential backup at the time of the loss of a power supply. Accordingly, the server 10 can perform a normal shutdown even if the capacity of the battery 51 has been reduced.

Furthermore, the server 10 measures the time period needed for the differential backup and then estimates, on the basis of the measured time period, the time period needed for the differential backup at the time of the loss of a power supply. Thus, the server 10 can accurately estimate the time period needed for a differential backup at the time of the loss of a power supply. Consequently, the server 10 can normally determine, when the capacity of the battery 51 is reduced, whether a normal shutdown can be performed. Consequently, the server 10 can reduce a possibility of a dirty shutdown.

Furthermore, the server 10 measures the time period needed for a differential backup, measures the task operation rate at the time at which the differential backup is being executed, and uses the product of the measured time period and the task operation rate as the time period needed to execute the differential backup at the time of the loss of a power supply. At this point, if the server 10 executes only the differential backup at the time of the loss of a power supply, the server 10 shortens the time period for which the operation is performed by the electrical power supplied by the battery 51. Consequently, because the server 10 can estimate the time period needed when only a differential backup is executed at the time of the loss of a power supply, the server 10 can shorten the amount of time for which the operation is executed by the electrical power supplied by the battery 51 and thus the capacity of the battery 51 can be reduced.

Furthermore, the server 10 stores therein the duration association information 41 in which the amount of electrical power consumption of the server 10 is associated with the backup available time period. The server 10 reads, from the duration association information 41, the backup available time period that is associated with the amount of electrical power consumed by the server 10 when the server 10 executes the differential backup and then determines whether the estimated backup time period is longer than the read time. Consequently, the server 10 can accurately determine whether a normal shutdown can be executed.

Furthermore, the server 10 uses the product of the backup available time period that is read from the duration association information 41 and the charging rate of the battery 51 as a backup time period and determines whether the estimated backup time period is longer than the backup time period. Consequently, the server 10 can accurately determine a normal shutdown can be executed within a backup time period in accordance with the charging rate of the battery 51.

Furthermore, the server 10 allows the CPU 31 to operate the hypervisor 37 and allows the VMs 35c and 36c to operate on the hypervisor 37. Then, by using the backup function included in the hypervisor 37, the server 10 executes the differential backup of the VMs 35c and 36c, the guest OSs 35b and 36b, and the applications 35a and 36a. Consequently, because the server 10 shortens the period of time needed for the differential backup, the capacity of the battery 51 can be reduced.

Furthermore, the battery module 50 includes the state display LED unit 55 that indicates whether the server 10 executes a differential backup. Consequently, even when the monitor 4 does not operate due to a power failure, the battery module 50 can notify a user whether a differential backup is being executed normally by the server 10.

Furthermore, if the time interval for which a differential backup is executed is shorter than a predetermined value, the server 10 notifies a user that a normal shutdown is not able to be executed. Consequently, the server 10 sends a notification to a user when a dirty shutdown occurs with the current capacity of the battery 51 and then allows the user to take measures of, for example, addition or the like.

### [b] Second Embodiment

The embodiment of the present invention has been described; however, the present invention is not limited to the embodiment described above and can be implemented with various kinds of embodiments other than the embodiment described above. Therefore, another embodiment included in the present invention will be described below as a second embodiment.

(1) Battery Module 50

In the information processing system 1 described above, the state display LED unit 55 is installed in the battery module 50 that is used as an external device and that is a device other than the server 10. However, the embodiment is not limited thereto. For example, the information processing system 1 prepares space, such as a 5-inch bay or the like, in the self-contained server 10 and has mounted thereon a battery module in the prepared space. At this point, by making the state display LED unit 55 in the battery module faces the front surface of the server 10, i.e., faces the user side, the user can easily view and check whether the server 10 normally execute a differential backup when a loss of a power supply occurs.

Furthermore, the function of the battery module 50 may also be included in the server 10. Namely, the server 10 may also have the same function as that performed by the battery module 50, thereby it is possible to reduce the amount of space needed for the information processing system 1.

(2) Estimated Backup Time Period

The server 10 described above uses the produce of the time period needed for a differential backup and the task operation rate as the estimated backup time period. However, the embodiment is not limited thereto. For example, the server 10 may also calculate more accurate estimated backup time period by taking into consideration of the time elapsed since a differential backup, the number of running VMs, the number of running applications, or the like.

For example, by calculating the product of the number of running VMs, the number of running applications, the time elapsed since a differential backup, and a predetermined counting, the server 10 estimates an amount of data targeted for a differential backup. Then, the server 10 may also calculate the time period needed for a backup of the estimated data.

(3) Backup Time Period

The server 10 described above uses the product of the backup available time period that is read from the duration association information 41 and the charging rate of the battery 51 as a backup time period. However, the embodiment is not limited thereto. For example, if the time period for which the battery 51 operates the server 10 can be guaranteed, the server 10 stores therein the guaranteed time period as the backup time period and then determines, by using the stored backup time period, whether a normal shutdown can be executed.

(4) Virtualization

The server 10 described above operates a virtualized system by operating the VMs 35c and 36c that are virtual machines on the hypervisor 37 and uses the backup function included in the hypervisor 37. However, the embodiment is not limited thereto. Namely, instead of virtualization, the server 10 may also execute a differential backup by using the function of the installed OS or another piece of software.

(5) Program

The software 35, such as the management software 39, the hypervisor 37, or the like, described in the embodiments may also be implemented by a software program prepared in advance and executed by a computer, such as a personal computer, a workstation, or the like. The program can be distributed via a network, such as the Internet. Furthermore, the program is stored in a computer readable recording medium, such as a hard disk, a flexible disk (FD), a compact disc read only memory (CD-ROM), a magneto optical disc (MO), and a digital versatile disc (DVD). Furthermore, the program can also be implemented by a computer reading it from the recording medium.

According to an aspect of an embodiment of the present invention, an advantage is provided in that the capacity of a battery can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus that duplicates the state of the own apparatus into a storage device at the time of the loss of a power supply, the information processing apparatus comprising:
a duplicating unit that duplicates, in the storage device at a predetermined time interval, a difference of the state of the information processing apparatus;
an estimating unit that estimates the time period needed by the duplicating unit to duplicate the difference;
a determining unit that determines whether the time period estimated by the estimating unit is longer than the time period for which a battery that supplies electrical power to the information processing apparatus at the time of the loss of a power supply operates the information processing apparatus; and
an updating unit that updates, when the determining unit determines that the time period estimated by the estimating unit is longer than the time period for which the battery operates the information processing apparatus, the time interval for which the duplicating unit executes the duplication to a smaller value.

2. The information processing apparatus according to claim 1 further comprising a measuring unit that measures the time period needed by the duplicating unit to perform the duplication, wherein
the estimating unit estimates, on the basis of the time period measured by the measuring unit, the time period needed by the duplicating unit to execute the duplication at the time of the loss of a power supply.

3. The information processing apparatus according to claim 1, wherein
the measuring unit measures the time period needed by the duplicating unit to execute the duplication and measures the operation rate of the duplicating unit during the duplication, and
the estimating unit uses the product of the time period and the operation rate measured by the measuring unit as the time period needed to execute the duplication at the time of the loss of a power supply.

4. The information processing apparatus according to claim 1 further comprising a storing unit that stores therein an operation time period association table in which an amount of electrical power consumed by the information processing apparatus is associated with the time period for which the battery operates the information processing apparatus, wherein
the determining unit identifies the time period that is associated with the amount of electrical power consumed by the information processing apparatus from the operation time period association table stored in the storing unit and determines whether the time period estimated by the estimating unit is longer than the identified time period.

5. The information processing apparatus according to claim 3 further comprising a monitoring unit that monitors the charging rate of the battery, wherein
the determining unit calculates the product of the time period that is identified from the operation time period association table and the charging rate of the battery that is monitored by the monitoring unit and determines whether the time period estimated by the estimating unit is longer than the calculated value.

6. The information processing apparatus according to claim 1 further comprising an arithmetic unit that operates a virtual system obtained by virtualizing the information processing apparatus, wherein
the duplicating unit duplicates, by using a backup function in the virtual system that is operated by the arithmetic unit, the difference of the state of the information processing apparatus.

7. The information processing apparatus according to claim 1, wherein the battery includes a display device that indicates whether the information processing apparatus is executing the duplication.

8. The information processing apparatus according to claim 1 further comprising a notifying unit that notifies, when the time interval updated by the updating unit is shorter than a predetermined value, a user that the duplication is not able to be executed normally.

9. A duplication method comprising:
duplicating, at a predetermined time interval performed by an information processing apparatus that duplicates the state of the own apparatus into a storage device at the time of the loss of a power supply, a difference of the state of the information processing apparatus;
estimating, performed by the information processing apparatus, the time period needed to duplicate the difference;
determining, performed by the information processing apparatus, whether the estimated time period is longer than the time period for which a battery that supplies electrical power to the information processing apparatus at the time of the loss of a power supply operates the information processing apparatus; and
updating, performed by the information processing apparatus when it is determined at the determining that the estimated time period is longer than the time period for which the battery operates the information processing apparatus, the time interval for which the duplication is executed to a smaller value.

10. A non-transitory computer-readable recording medium having stored therein a duplication program causing an information processing apparatus that duplicates the state of the own apparatus into a storage device at the time of the loss of a power supply to execute a process comprising:
duplicating, at a predetermined time interval, a difference of the state of the information processing apparatus;
estimating the time period needed to duplicate the difference;
determining whether the estimated time period is longer than the time period for which a battery that supplies electrical power to the information processing apparatus at the time of the loss of a power supply operates the information processing apparatus; and
updating, when it is determined at the determining that the estimated time period is longer than the time period for which the battery operates the information processing apparatus, the time interval for which the duplication is executed to a smaller value.
